(19) United States
(12) Patent Application Publication
(10) Pub. No.: US 2011/0185700 A1
(43) Pub. Date: Aug. 4, 2011

(54) Jet engine bird diverters

(76) Inventor: Fred Michael Newcomer, Columbia Falls, ME (US)

(21) Appl. No.: 12/657,848

(22) Filed: Jan. 29, 2010

(51) Int. Cl. F02C 7/055

(52) U.S. Cl. 60/39.092

(57) ABSTRACT

This invention is a series of Jet engine bird diverters designed to attach to the side(s) of the jet engines and the leading edge of the jet engine housing or become an integral part of the leading edge of the jet engine housing. The designs embody aerodynamic structural titanium support systems that extend forward and terminate directly in front of the centerline of the jet engine terminating at a circular titanium forward spoke connecter that receives a sharply angled series of identical bird deflection spokes that trail back and attach to the perimeter of the jet engine intake housing or nacelle. All of the support elements and deflection members shall be aeronautically designed to direct a maximum amount of air into the jet engine.

This invention is for several types of Jet engine bird diverters which are designed to make air travel safer and prevent damage to the turbines and all other engine parts of all types of jet aircraft in the event of a bird strike. The invention consists of an aerodynamic collar that encircles and tightly surrounds the leading edge of the engine intake and attaches directly to the outside housing of the engine intake. This aerodynamic collar shall have connection points that are equally spaced around the perimeter to receive engineered titanium or stainless steel spokes or rigid wire that extend forward at a steep angle to attach to the trailing edge of an aerodynamically designed titanium structural member. (Please note that although I refer to these members as spokes, they are actually specially designed very high strength thin rods or rigid wires with one end tension adjustability like bicycle spokes.) Alternately, the existing leading edge engine surround may be reconfigured to become an integral part of the bird diverter and shall incorporate all of the spoke connection points as well as increasing the air flow opening area.

There shall be one aerodynamically designed titanium structural member that attaches to the bottom of the jet engine along it's centerline, and curves upward and forward to the point where all spokes or wires converge. All of the spokes shall be exactly identical and of the same length. I suspect that this complete system will be stabilized from lateral movement and vibrational movement due to the fact that the spokes will secure and anchor the system in this regard. However, if a single titanium structural member proves to be insufficient for stability, two titanium structural members shall attach to each side of the jet engine, or three titanium structural members shall be placed equidistant around the engine, and shall converge at the forward point where the spokes are attached.

The aerodynamic collar around the engine intake as referred to in the above paragraph (0001) shall also be attached to the titanium member(s), or shall be part of an integral system of the engine intake housing that will receive and secure the tensile steel deflection spokes where they attach to the engine.

The spacing of these spokes where they join with the engine nacelle should be spaced at about 12 inches or less. The leading ends of the spokes shall all attach to the forward connector at less than a one inch spacing. All components forward of the engine shall be made as slender as possible in the direction of motion without sacrificing strength, to minimize air frictional drag and weight, and shall be designed to redirect the highest percentage of air into the jet engine intake.

The design of the forward most terminus shall receive all of the spokes in a circular configuration trailing the titanium support member. It shall have a circular spoke connection configuration to keep the size of the connector to a minimum. Another aerodynamic through bolted connection shall pass through the center of this connector and through the leading edge of the forward titanium support member. It shall also be designed to cause a Venturi effect to draw as much air into the engine intake as required for full functionality and high performance efficiency.

If calculations and tests show the air flow into the engine proves to be diminished from what is required for maximum engine performance, the inside diameter of the leading edge of the jet engine intake may need to be increased for balanced and optimal air flow into the jet engine to meet engine specifications.

The steep angle of the spokes should easily deflect a direct heavy bird strike away from the engine intake opening while moving at a very high speed. The spacing and steep angle of the spokes shall be designed to distribute the impact of a large bird over several spokes if the impact happens to occur midway between the connection points where the stress would be greatest on the spokes. I believe the maximum 12 inch spacing at the engine housing and the minimal structural spacing at the forward terminus is a good place to start the calculations and the field testing on these devices. All spokes can easily be checked for damage between flights. The small diameter of the spokes, and the direction of the spokes at a steep angle in the direction of flight should help to keep the air flow reduction into the jet engine intake to a minimum. Damaged spokes due to all bird strike impacts should be readily identifiable and able to be replaced quickly and easily during routine maintenance.

Military and specialized aircraft may also use this type of spaced spoke system with spacing and angled configurations that are specially designed for the type of engine intakes used. For example, high performance, high speed stealth fighter planes with large rectangular intakes against the fuselage may use a 4 inch spacing of very steeply angled parallel spokes running from the outer edge of the air intakes directly forward to the fuselage.

Aeronautical engineers could design and test various types of spoked or wire engine bird diverter systems for all types of military and specialized aircraft based upon this invention concept.

An alternate design approach to this bird diverter replaces the above single titanium structural member with equally spaced, slender titanium ovoid rods, (with their long axis in the direction of flight) attached directly to the main engine housing surround. The diameter of the opening may be increased to compensate for any air flow reduction as determined by actual field testing. The leading forward spoke connector will be similar to the connector described above (0005), with a similar forward aerodynamic titanium element to minimize air resistance.

Aeronautical engineering and field testing should be able to revise and refine these Jet engine bird diverters into prototypes that work efficiently with all types of aircraft jet engines, saving hundreds of millions of dollars annually in bird strike damage, and making air travel safer, therefore saving many human lives.

The choice of structural materials used for these Jet engine bird diverters are not limited to titanium and steel. If aeronautical engineers discover that other exotic materials such as carbon fiber, composites or other future inventions will be structurally superior and perform better than titanium and steel, they may be used.

All “Jet Engine Diverters” shall have integral de-icing systems consisting of an electrical resistance element at the leading edge of the spokes that heat the spokes and support structures and prevents ice formation. Alternatively, an enclosed tubular assembly shall capture a small portion of the jet engine exhaust and redirect it forward to the leading edge of the spokes to prevent the build up of any ice on the spokes and supports. This assembly may be incorporated within the support element(s), but in either case shall have the ability to be controlled by the pilot so that it may be in active de-icing mode, or inactivated in warmer weather.

Forward jet engine access shall be provided at the bottom of the forward edge of the engine nacelle directly adjacent to the titanium support member. This access shall allow for a series of adjacent spokes to be released from the nacelle to allow an adequate opening for forward engine inspection and maintenance.

All spoke elements shall have an adjustable end at the engine surround nacelle so that all spokes may be torqued to the designed tension. All spokes shall also have a designed breaking point just slightly forward of the adjustable end, so that in the event of a heavy bird strike, if the spoke happens to fail, it will be at a position to allow the leading portion to trail behind its forward attachment without causing any damage to the spinning jet engine turbines.

The rear portion of the broken spoke shall remain in place in the nacelle until it is replaced. All aircraft shall carry replacement spokes so that any damage may be easily repaired during routine maintenance.

The tension, angle and spacing of all the deflection spokes shall be tested and engineered for maximum performance. All spoke elements shall be identical. If testing determines that the spoke spacing should be reduced, the forward spoke connector may have two or three spokes converging into the same slot to allow an increase in the total number of spokes. The leading engine surround nacelle shall have equally spaced points of connection for the trailing ends of all deflection spoke members on the outside surface of the nacelle. The inside diameter of the nacelle shall be increased as required to allow for the optimal amount of air intake for jet engine maximum performance.

### HISTORY OF THIS INVENTION

Many hundreds of millions of dollars are lost by the aircraft industry annually by bird strikes of large birds such as: Water Fowl, Canadian Geese, Snow Geese, Gulls, Vultures, Raptors, Crows, large flocks of Starlings and other large birds. Most of the damage is to the jet engines of all types of aircraft, often posing great risk to human life. For example, there were 5900 total reported strikes in year 2000 alone, and the FDA estimates that this only represents about 20% of the total strikes that occurred. The recent and unusual double bird strike that forced a commercial airliner to miraculously ditch in the Hudson River (with the great professionalism and skill of the Captain) really brings this hazard to light. These aerodynamic designs are simply very high tech impact deflection devices that are conceptually much along the lines of the antique “cow catchers” used on steam locomotives in the 1800's to deflect many hazards.

### DESCRIPTION OF THE DRAWINGS

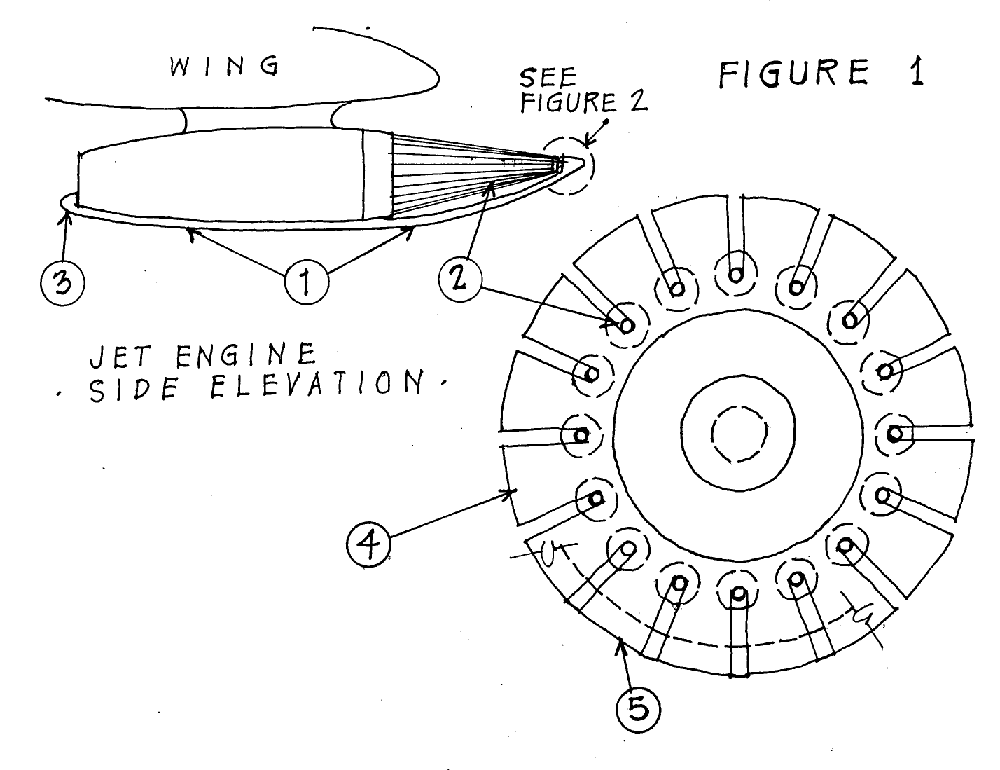

FIG. 1 shows the side elevation of a typical airline engine with the jet engine bird diverter in place. It also shows a front view of the forward spoke connector.
1) Titanium structural member.
2) Stainless steel spokes.
3) Hot exhaust air capture to de-ice spokes.
4) 16 spoke titanium forward spoke connecter. Front view from inside.
5) A removable shear ring may be added to increase impact strength. Two pieces snap into place and are secured with set screws.

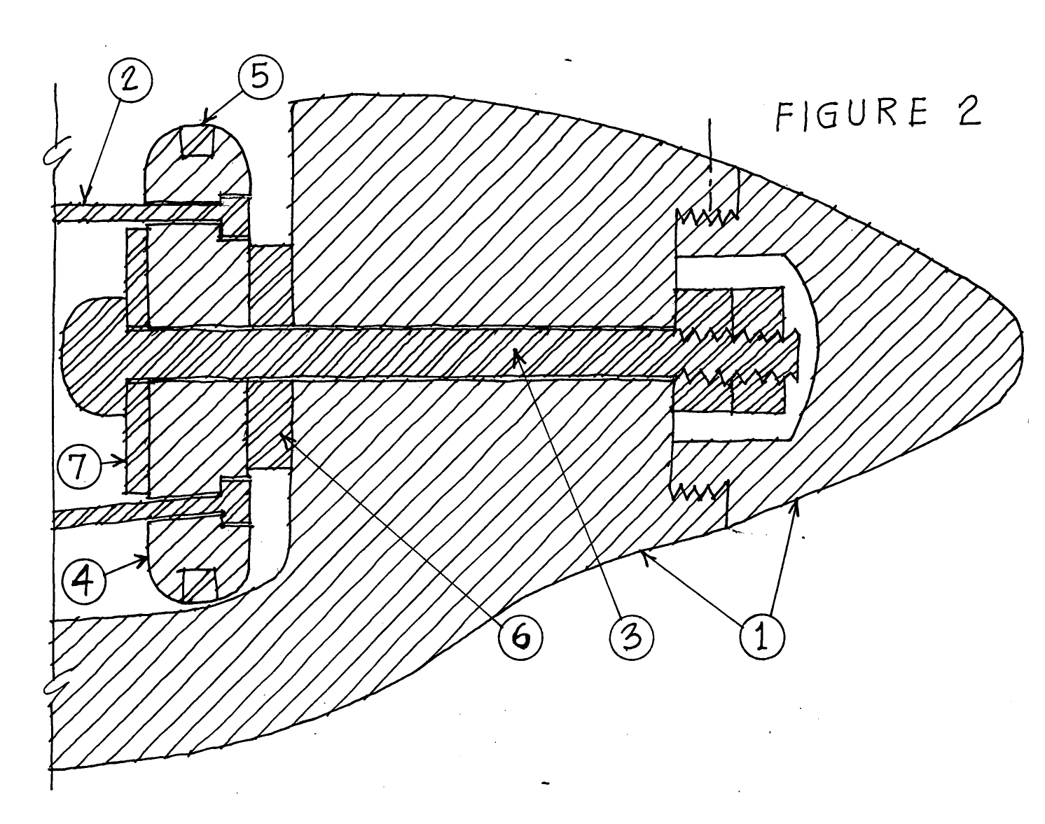

FIG. 2 shows a sectional detail of the forward most titanium structural member and it's attachment to the forward spoke connector.
1) Titanium nose cone and structural member.
2) Stainless steel spokes.
3) Bolted connection.
4) 16 spoke titanium forward spoke connecter. Sectional view.
5) A removable shear ring may be added to increase impact strength. Two pieces snap into place and are secured with set screws.
6) Stainless steel spacer.
7) Stainless steel washer.

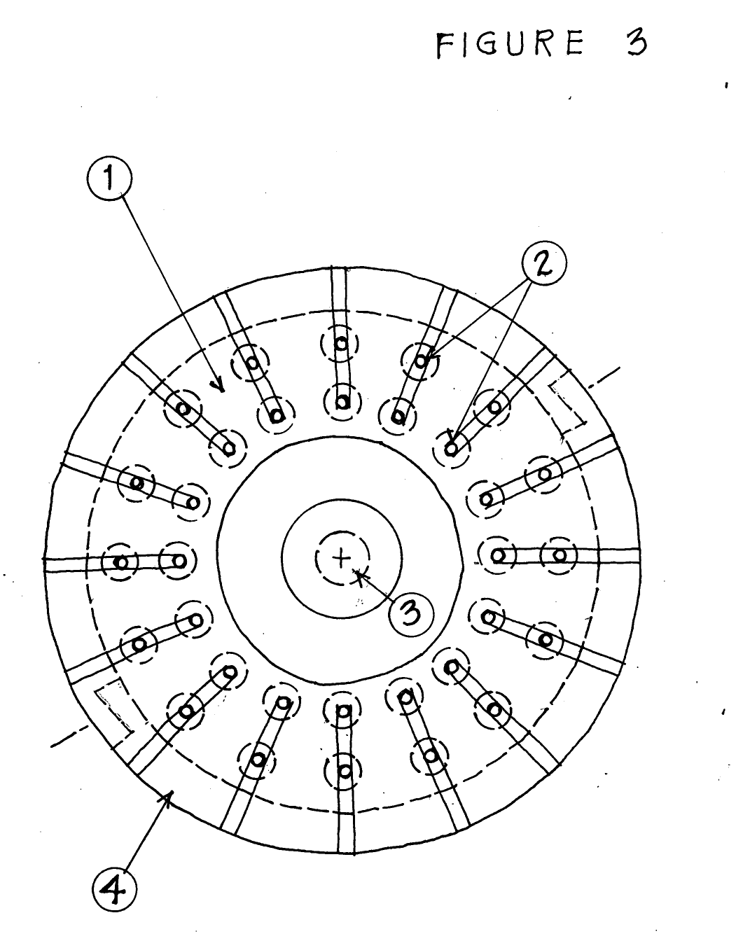

FIG. 3 shows a front view of an alternate forward spoke connector designed to receive two spokes per slot.
1) 32 spoke titanium forward spoke connector. Front view from inside.
2) Stainless steel spokes.
3) Bolted connection.
4) A removable shear ring may be added to increase impact strength. Two pieces snap into place and are secured with set screws.

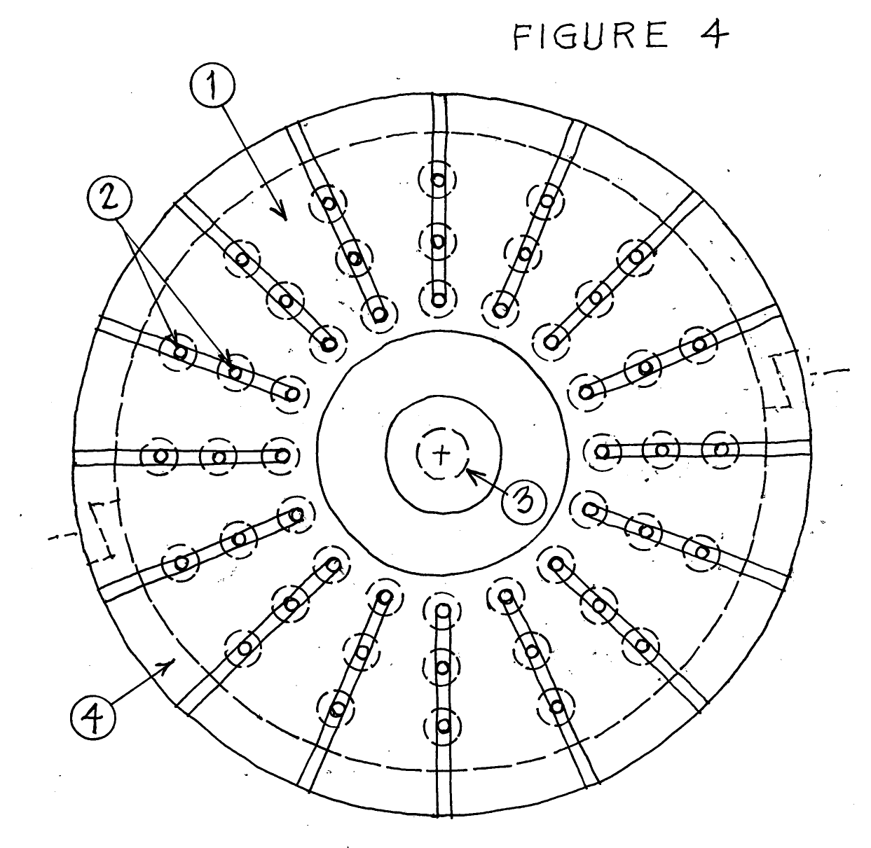

FIG. 4 shows a front view of an alternate forward spoke connector designed to receive three spokes per slot.
1) 48 spoke titanium forward spoke connecter. Front view from inside.
2) Stainless steel spokes.
3) Bolted connection.
4) A removable shear ring may be added to increase impact strength. Two pieces snap into place and are secured with set screws.

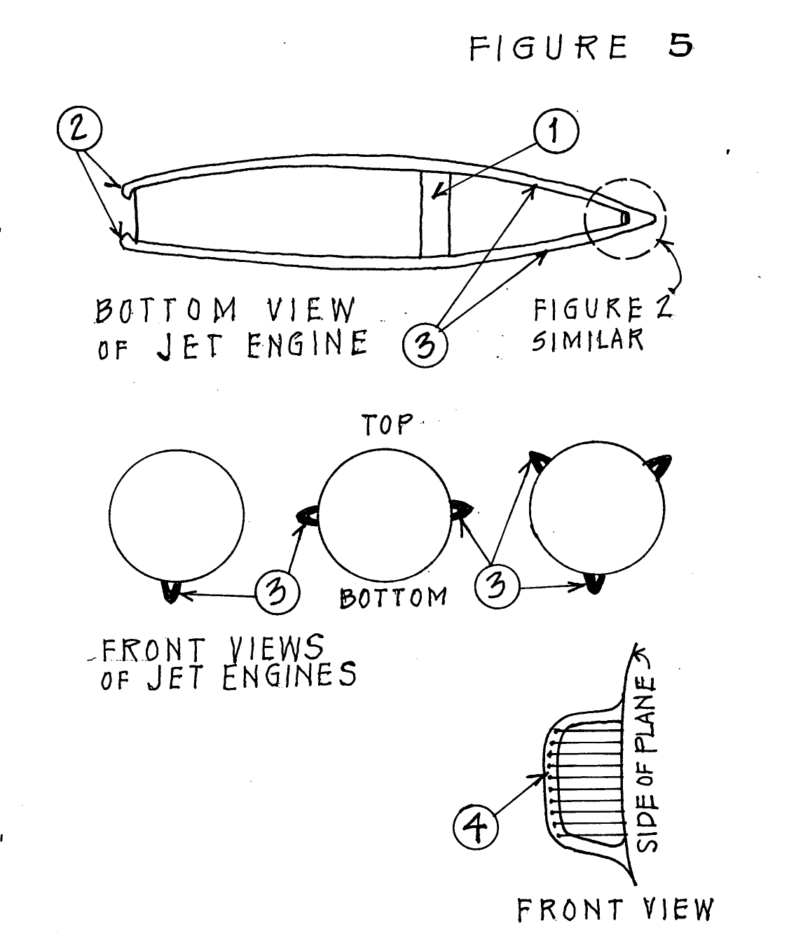

FIG. 5 shows a bottom view of a typical airline engine with titanium supports on each side of the engine. These supports would be horizontally aligned with the wings and aerodynamically designed to enhance the airplanes performance. It also shows the front views of jet engines showing the location of titanium structural members.
1) Front nacelle of jet engine. (spokes not shown)
2) Exhaust catchment points at rear of titanium structural members.
3) Titanium structural members.
4) Rectangular jet engine nacelle with bird strike deflectors running forward and secured against the side of the aircraft.

I claim:

1) This invention is a series of Jet engine bird diverters that consist of a collar that surrounds or is an integral part of the jet engine intake housing or nacelle. The size and shape shall match the configuration of the existing engine intake. The opening size may be increased to adjust the engine air intake for maximum engine performance. An aerodynamic titanium support member, or a number of members shall extend well forward from the collar or housing to a point on the extended axis of the jet engine centerline. Final engineering calculations and prototype testing may require adjusting the jet engine opening intake housing size to maintain maximum engine operational efficiency in accordance with the required engine specifications with the Jet engine bird diverter in place.

2) Jet engines with other than round intake nacelles such as specialized military aircraft, shall have collars that exactly conform to the intake configurations with compatible spokes and termini. Final engineering calculations for each specific design may require increasing the jet engine opening intake size to maintain maximum engine operational efficiency directly in accordance with the jet engine specifications with the Jet engine bird diverter in place.

3) Other alternate exotic materials including carbon fiber, specialized alloys, man made tensile fibers such as spider web developments, composites and/or any other appropriate existing or future material may be used in place of titanium or stainless steel for these assemblies if design engineers determine that they are superior in performance to titanium or stainless steel. I fully expect that these designs will evolve as new materials are invented and applied to this invention.
